(19) United States
(12) Patent Application Publication
(10) Pub. No.: US 2006/0025004 A1
(43) Pub. Date: Feb. 2, 2006

(54) Electric coupler with positioning device

(76) Inventor: Pei-Chen Chen, Shu-Lin Chen (TW)

Correspondence Address: Keith Kline;PRO-TECHTOR INTERNATIONAL, 20775 Norada Court, Saratoga, CA, 95070-3018, US

(21) Appl. No.: 10/903,789

(22) Filed: Jul. 29, 2004

(51) Int. Cl. H01R 13/627

(52) U.S. Cl. 439/354

(57) ABSTRACT

An electric coupler includes an insulating body having a coupling section at a front end thereof. The insulating body receives a plurality of terminals therein for coupling with a correspondingly constructed electric coupler. The electric coupler further includes two arcuate resilient members each including a first end integrally formed with an associated one of two opposite sides of the insulating body and a second end integrally formed with the associated one of the opposite sides of the insulating body, with a remaining portion of each arcuate resilient members being spaced from the associated one of the opposite sides of the insulating body. The remaining portion of each arcuate resilient member includes a retaining protrusion formed on a section thereof adjacent to the second end of the arcuate resilient member, with the retaining protrusion being engaged with and thus positioned by the correspondingly constructed electric coupler.

### BACKGROUND OF THE INVENTION

1. Field of the Invention

The present invention relates to an electric coupler. In particular, the present invention relates to an electric coupler with a positioning device for a liquid display for a notebook type computer or the like.

2. Description of the Related Art

Miniaturization of notebook (or laptop) type computers and liquid displays thereof is a developing trend. Thus, the electric couplers for the liquid displays of the notebook type computers must be miniaturized, too. A typical electric coupler for a liquid display of a notebook type computer includes an insulating body with at least one metal or plastic engaging member for coupling with a correspondingly constructed coupler. However, manufacturing of the metal engaging member is troublesome and costly while the plastic engaging member could not provide a reliable positioning effect and is apt to be damaged, as the plastic engaging member is an arm extending from the insulating body and having a free end.

### SUMMARY OF THE INVENTION

In accordance with an aspect of the invention, an electric coupler includes an insulating body having a coupling section at a front end thereof. The insulating body receives a plurality of terminals therein for coupling with a correspondingly constructed electric coupler. The electric coupler further includes two arcuate resilient members each including a first end integrally formed with an associated one of two opposite sides of the insulating body and a second end integrally formed with the associated one of the opposite sides of the insulating body, with a remaining portion of each arcuate resilient members being spaced from the associated one of the opposite sides of the insulating body. The remaining portion of each arcuate resilient member includes a retaining protrusion formed on a section thereof adjacent to the second end of the arcuate resilient member, with the retaining protrusion being engaged with and thus positioned by the correspondingly constructed electric coupler.

In an embodiment of the invention, the first end of each arcuate resilient member is integrally formed with an associated side of the coupling section. The second end of each arcuate resilient member is integrally formed with a rear end of the insulating body. The remaining portion of each arcuate resilient member includes a shoulder section. The remaining portion of each arcuate resilient member includes a pressing section adjacent to the second end of the arcuate resilient member. The pressing section of each arcuate resilient member includes a plurality of ridges on an outer face thereof. The remaining portion of each arcuate resilient member includes an inclined face facing the second end of the arcuate resilient member and a stop face behind the inclined face and facing the first end of the arcuate resilient member.

Thus, an electric coupler in accordance with the present invention provides a reliable positioning effect while having improved structural strength. Further, operation of the electric coupler is easy. Further, the electric coupler is durable and can be manufactured at a low cost.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of an electric coupler in accordance with the present invention.

FIG. 2 is a sectional view of the electric coupler in FIG. 1.

FIG. 3 is a sectional view of the electric coupler in FIG. 1 and another electric coupler.

FIG. 4 is a sectional view similar to FIG. 3, wherein the electric coupler is coupled with another electric coupler.

FIG. 5 is a sectional view similar to FIG. 4, illustrating disengaging of the electric coupler from another electric coupler.

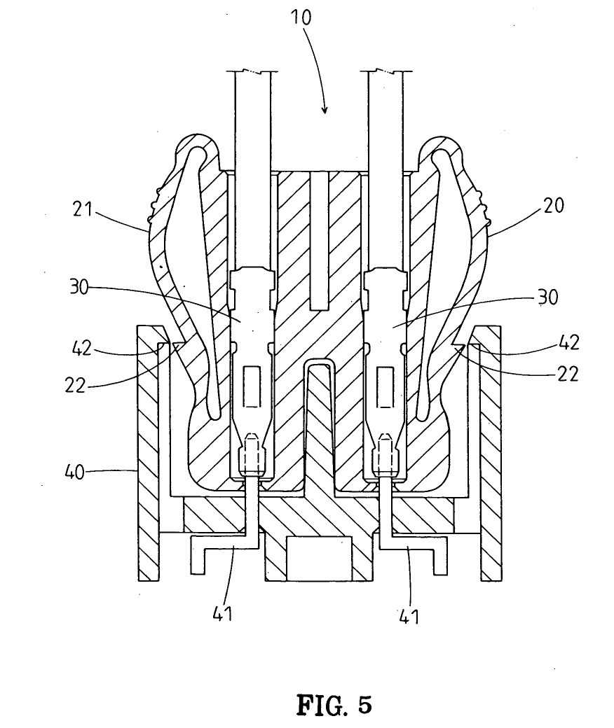

FIG. 6 is a perspective view illustrating a modified embodiment of the electric coupler in accordance with the present invention.

FIG. 7is a perspective view illustrating another modified embodiment of the electric coupler in accordance with the present invention.

FIG. 8 is a sectional view illustrating a further modified embodiment of the electric coupler in accordance with the present invention.

FIG. 9 is a perspective view illustrating still another modified embodiment of the electric coupler in accordance with the present invention.

FIG. 10 is a perspective view illustrating yet another modified embodiment of the electric coupler in accordance with the present invention.

### DETAILED DESCRIPTION OF THE PREFERRED EMBODIMENT

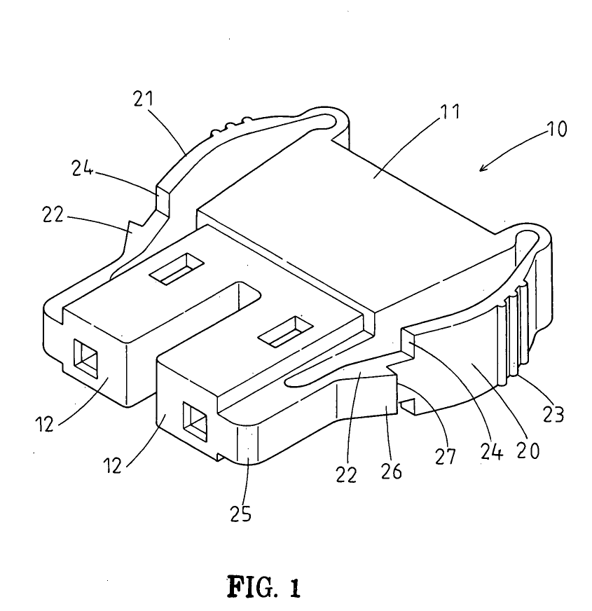

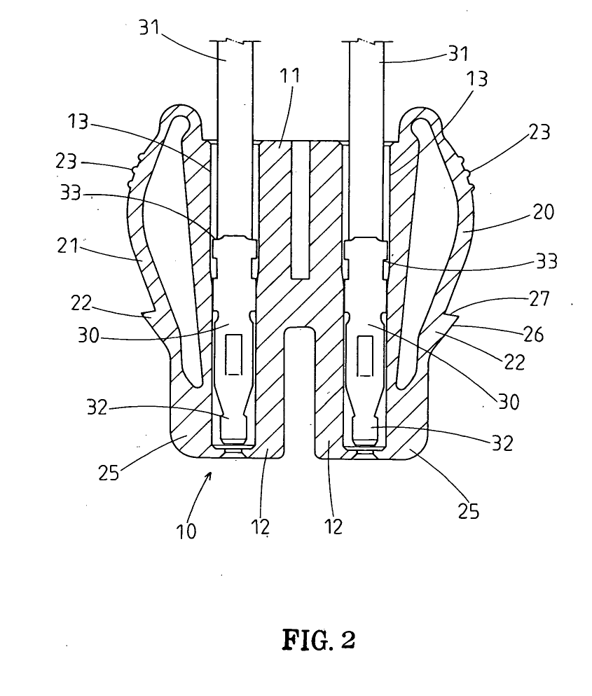

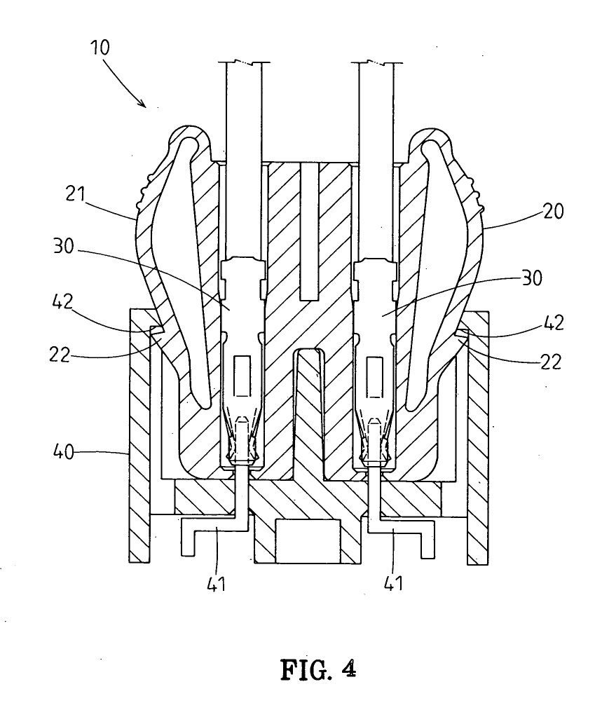

Referring to FIGS. 1 and 2, an electric coupler 10 in accordance with the present invention comprises an insulating body 11 including a front end having two coupling sections 12. The insulating body 11 further includes a plurality of longitudinal holes 13 for receiving and positioning a corresponding number of terminals 30. Each terminal 30 includes a front end 32 for coupling with a pin 41 of another electric coupler 40 constructed correspondingly (FIG. 4). Each terminal 30 further includes a rear end with a pair of clamping members 33 for clamping a cable 31 and wires (not labeled) in the cable 31.

The electric coupler 10 further includes two plastic arcuate resilient members 20 and 21 respectively formed on two opposite sides of the insulating body 11. Each plastic arcuate resilient member 20, 21 includes a first end integrally formed with an associated one of the opposite sides of the insulating body 11 and a second end integrally formed with the associated one of the opposite sides of the insulating body 11, forming a loop structure; namely, the remaining portion of each plastic arcuate resilient member 20, 21 is spaced from the associated one of the opposite sides of the insulating body 11. A retaining protrusion 22 extending from a front section of the remaining portion of each plastic arcuate resilient member 20, 21.

In this embodiment, the first end of each plastic arcuate resilient member 20, 21 is integrally formed with a side of an associated one of the coupling sections 12 and forms a part 25 of the associated one of the coupling sections 12. The second end of each plastic arcuate resilient member 20, 21 is integrally formed with a rear end of the insulating body 11. Further, the remaining section of each plastic arcuate resilient member 20, 21 includes a shoulder section 24 followed by a pressing section 23. Preferably, the pressing section 23 includes a plurality of ridges 23a on an outer face thereof to prevent from slipping while pressing the pressing section 23 inward toward the insulating body 11. The coupling sections 12 may be deemed as a single coupling section spaced by a slit or gap (not labeled).

Since two ends of each plastic arcuate resilient member 20, 21 are integrally formed with the insulating body 11 with the remaining portion of each plastic arcuate resilient member 20, 21 being spaced from the insulating body 11, the remaining portion of each plastic arcuate resilient member 20, 21 is resilient and deformable and has improved structural strength. Thus, the electric coupler 10 of the plastic arcuate resilient member 20, 21 is more durable than the conventional electric coupler. Further, the electric coupler 10 can be manufactured at a low cost. Further, the retaining protrusion 22 of each plastic arcuate resilient member 20, 21 includes an inclined face 26 facing the second end of the plastic arcuate resilient member 20, 21 and a stop face 27 behind the inclined face 26 and facing the first end of the plastic arcuate resilient member 20, 21.

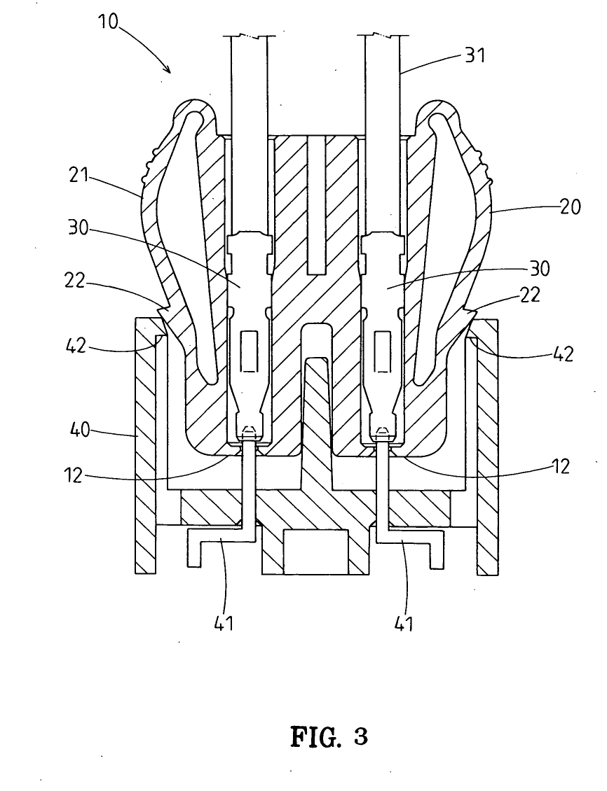

As illustrated in FIG. 3, when coupling with the correspondingly constructed electric coupler 40, the front end of the electric coupler 10 is inserted into the electric coupler 40. The inclined face 26 of each plastic arcuate resilient member 20, 21 assists in insertion of the electric coupler 10. During coupling, the front section of the remaining portion of each plastic arcuate resilient member 20, 21 and the retaining protrusion 22 are compressed inward toward the insulating body 11. After passing two hook sections 42 of the electric coupler 40, each plastic arcuate resilient member 20, 21 restores its shape, with the retaining protrusions 22 being engaged with and thus positioned by the hook sections 42 of the electric coupler 40 and with the terminals 30 being electrically connected to the pins 41.

When disengaging the electric coupler 10 from the electric coupler 40, the plastic arcuate resilient members 20 and 21 are pressed inward at, e.g., the pressing sections 23, causing disengagement of the retaining protrusions 22 from the hook sections 42 of the electric coupler 40 and thus allowing subsequent removal of the electric coupler 10 from the electric coupler 40.

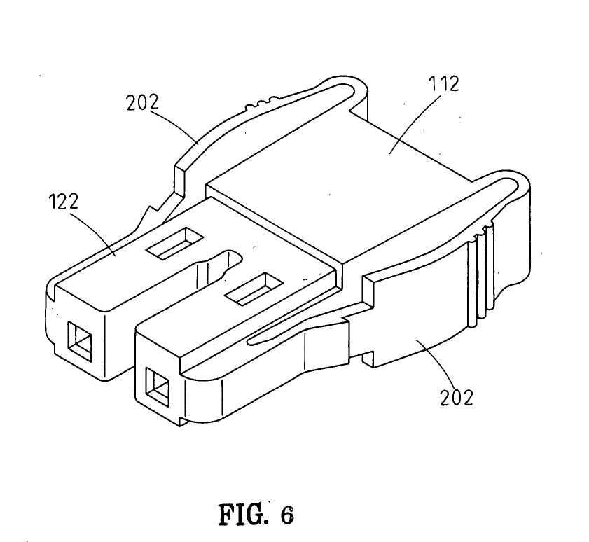

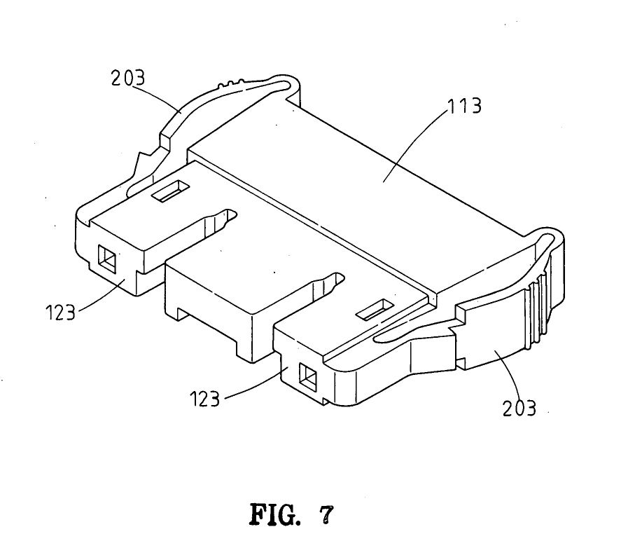

FIG. 6 illustrates a modified embodiment of the electric coupler, wherein the electric coupler includes an insulating body 112 with two plastic arcuate resilient members 202 similarly constructed as the embodiment in FIG. 1, with the insulating body 112 having two coupling sections 122 of a smaller size. FIG. 7 illustrates another modified embodiment of the electric coupler, wherein the electric coupler includes an insulating body 113 with two plastic arcuate resilient members 203 similarly constructed as the embodiment in FIG. 1, with the insulating body 113 having two coupling sections 123 spaced by a greater distance.

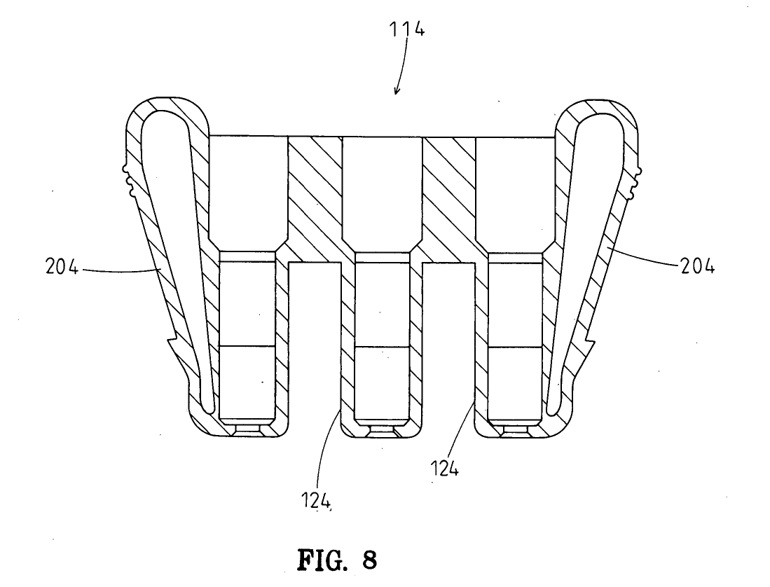

FIG. 8 illustrates a further modified embodiment of the electric coupler, wherein the electric coupler includes an insulating body 114 with two plastic arcuate resilient members 204 similarly constructed as the embodiment in FIG. 1, with the insulating body 114 having three coupling sections 124 and with an end of each plastic resilient members 204 being integrally formed with an associated one of two outer coupling sections 124.

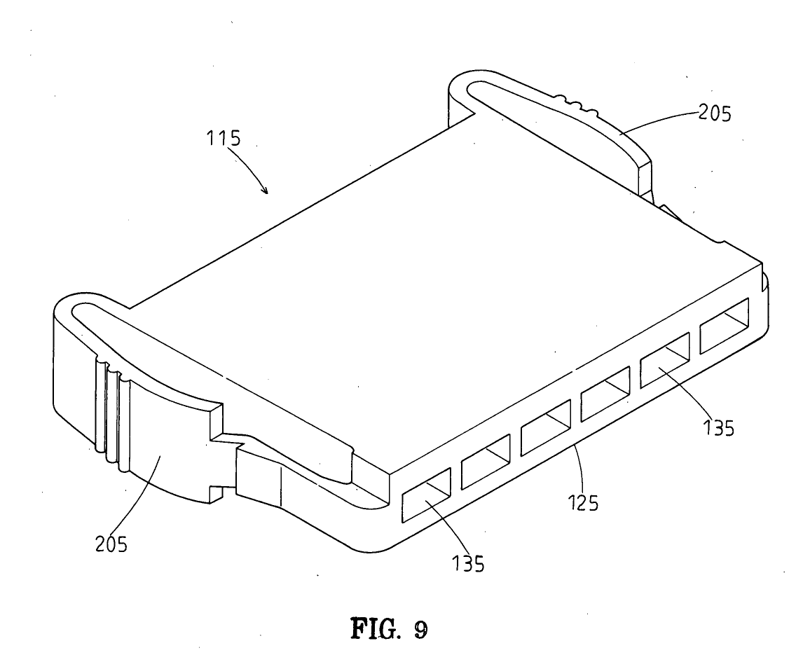

FIG. 9 illustrates still another modified embodiment of the electric coupler, wherein the electric coupler includes an insulating body 115 with two plastic arcuate resilient members 205 similarly constructed as the embodiment in FIG. 1, with the insulating body 115 having a coupling section 125 with a plurality of coupling holes 135.

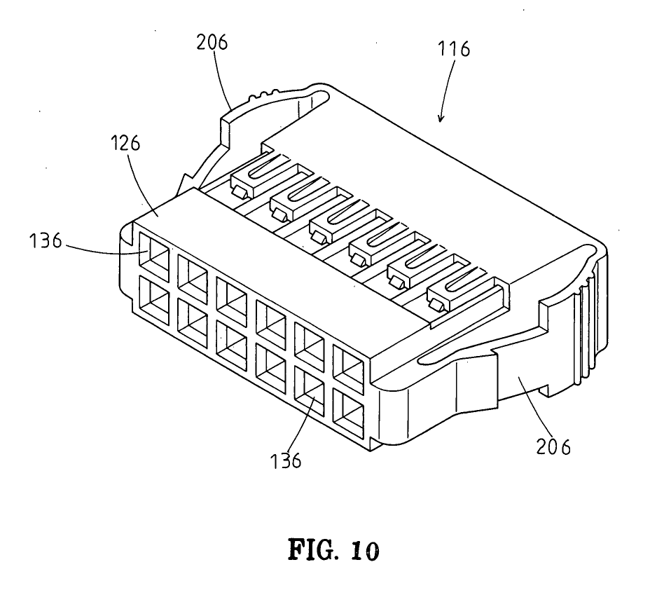

FIG. 10 illustrates yet another modified embodiment of the electric coupler, wherein the electric coupler includes an insulating body 116 with two plastic arcuate resilient members 206 similarly constructed as the embodiment in FIG. 1, with the insulating body 116 having a coupling section 126 with two rows of coupling holes 136.

Although specific embodiments have been illustrated and described, numerous modifications and variations are still possible without departing from the essence of the invention. The scope of the invention is limited by the accompanying claims.

1. An electric coupler comprising:
an insulating body including a coupling section at a front end thereof, the insulating body being adapted to receive a plurality of terminals therein for coupling with a correspondingly constructed electric coupler, the insulating body further including two opposite sides; and
two arcuate resilient members each including a front end integrally formed with an associated one of the opposite sides of the insulating body and a rear end integrally formed with the associated one of the opposite sides of the insulating body, with a remaining portion of each said arcuate resilient members being spaced from the associated one of the opposite sides of the insulating body, the remaining portion of each said arcuate resilient member including a retaining protrusion formed on a front section thereof adjacent to the second end of the arcuate resilient member, with the retaining protrusion being adapted to engage with and thus positioned by the correspondingly constructed electric coupler;
the remaining portion of each said arcuate resilient member including a pressing section adjacent to the rear end of the arcuate resilient member;
the pressing portions being located outside the correspondingly constructed electric coupler when the retaining protrusions are engaged with and thus positioned by the correspondingly constructed electric coupler; and
a distance between the pressing portion of each said arcuate resilient member and the associated one of the opposite sides of the insulating body being greater than that between an associated one of the retaining protrusions and the associated one of the opposite sides of the insulating body.

2. The electric coupler as claimed in claim 1, wherein the front end of each said arcuate resilient member is integrally formed with an associated side of the coupling section.

3. The electric coupler as claimed in claim 1, wherein the rear end of each said arcuate resilient member is integrally formed with a rear end of the insulating body.

4. The electric coupler as claimed in claim 1, wherein the remaining portion of each said arcuate resilient member includes a shoulder section.

5. (canceled)

6. The electric coupler as claimed in claim 1, wherein the pressing section of each said arcuate resilient member includes a plurality of ridges on an outer face thereof.

7. The electric coupler as claimed in claim 1, wherein the remaining portion of each said arcuate resilient member includes an inclined face facing the front end of the arcuate resilient member and a stop face behind the inclined face and facing the rear end of the arcuate resilient member.
